(19) United States
(12) Patent Application Publication
(10) Pub. No.: US 2016/0337018 A1
(43) Pub. Date: Nov. 17, 2016

(54) Use of Different Precoders for Superposed Signals in Downlink Multiuser Superposition Transmission

(71) Applicant: MEDIATEK INC., Hsinchu (TW)

(72) Inventors: Chien-Hwa Hwang, Hsinchu County (TW); Yi-Ju Liao, Hsinchu City (TW); Lung-Sheng Tsai, Tainan City (TW); Pei-Kai Liao, Nantou County (TW)

(21) Appl. No.: 15/150,991

(22) Filed: May 10, 2016

Related U.S. Application Data
(60) Provisional application No. 62/160,100, filed on May 12, 2015.

(51) Int. Cl. H04B 7/04; H04W 72/04; H04L 5/00

(52) U.S. Cl. CPC H04B 7/0465; H04L 5/0026; H04L 5/0051; H04L 5/005; H04B 7/0426; H04B 7/0452; H04W 72/042

(57) ABSTRACT

A method of performing downlink multiuser superposition transmission (MUST) when different precoders are applied to superposed signals is proposed. For demodulation reference signal (DM-RS) transmission mode, the near-user can estimate the far-user's channel by means of separate DM-RS symbols. For common reference signal (CRS) transmission mode, the near-user can blindly detect code far-user's precoder that is not signaled to the near-user. As a result, even the downlink control information (DCI) format is designed for the situation using the same precoder for superposed signals, the MUST scheme works and the near-user receiver can separate the superposed signal for the far-user.

### CROSS REFERENCE TO RELATED APPLICATIONS

This application claims priority under 35 U.S.C. §119 from U.S. Provisional Application No. 62/160,100, entitled “Use of Different Precoders for Superposed Signals in Downlink Multiuser Superposition Transmission,” filed on May 12, 2015, the subject matter of which is incorporated herein by reference.

### TECHNICAL FIELD

The disclosed embodiments relate generally to mobile communication networks, and, more particularly, to methods for using different precoders in downlink multiuser superposition transmission (MUST).

### BACKGROUND

Long Term Evolution (LTE) is an improved universal mobile telecommunication system (UMTS) that provides higher data rate, lower latency and improved system capacity. In LTE systems, an evolved universal terrestrial radio access network includes a plurality of base stations, referred as evolved Node-Bs (eNBs), communicating with a plurality of mobile stations, referred as user equipment (UE). A UE may communicate with a base station or an eNB via the downlink and uplink. The downlink (DL) refers to the communication from the base station to the UE. The uplink (UL) refers to the communication from the UE to the base station. LTE is commonly marketed as 4G LTE, and the LTE standard is developed by 3GPP.

In a wireless cellular communications system, multiuser multiple-input multiple-output (MU-MIMO) is a promising technique to significantly increase the cell capacity. In MU-MIMO, the signals intended to different users are simultaneously transmitted with orthogonal (or quasi-orthogonal) precoders. On top of that, the concept of a joint optimization of MU operation from both transmitter and receiver's perspective has the potential to further improve MU system capacity even if the transmission and precoding is non-orthogonal. For example, the simultaneous transmission of a large number of non-orthogonal beams/layers with the possibility of more than one layer of data transmission in a beam. Such non-orthogonal transmission could allow multiple users to share the same resource elements without spatial separation, and allow improving the multiuser system capacity for networks with a small number of transmit antennas (i.e. 2 or 4, or even 1), where MU-MIMO based on spatial multiplexing is typically limited by wide beamwidth. An example of such joint Tx/Rx optimization associated with adaptive Tx power allocation and codeword level interference cancellation (CW-IC) receiver is recently a remarkable technical trend, including non-orthogonal multiple access (NOMA) and other schemes based on downlink multiuser superposition transmission (MUST).

Consider a wireless cellular communication system when the downlink MUST scheme is used. In MUST, the signals intended for two users are superposed and occupy the same time-frequency radio resource. To benefit from MUST, the two co-scheduled users generally need to have a large difference in the received signal quality, e.g., in terms of the received signal-to-interference-plus-noise ratio (SINR). In a typical scenario, one of the users is geometrically close to the base station, and the other user is geometrically far away from the base station. The former user and the latter user are also referred to as the near-user and far-user respectively.

Due to the complexity of the scheduling algorithm and the overhead of the channel state information (CSI) feedback, it is generally assumed that the same precoder is applied to superpose signals in the downlink MUST scheme. More specifically, the design of the downlink control information (DCI) and CSI feedback for the MUST transmission mode is concentrated and optimized for the case that the same precoder is applied to the superposed signals. However, as confining the precoder selection may degrade the performance gain of MUST due to the limited user pairing opportunities, using different precoders for superposed signals shall not be forbidden when, in some situation of user channel distribution, interfering condition, and so on, the MUST scheme is doable (i.e., the near-user receiver can separate superposed signals) based on DCI format and CSI feedback specifically designed for the case of using the same precoder.

When DCI format and CSI feedback are designed for the situation of using the same precoder for superposed signals, a solution is sought for the MUST scheme to work properly when different precoders are applied to the superposed signals.

### SUMMARY

A method of performing downlink multiuser superposition transmission (MUST) when different precoders are applied to superposed signals is proposed. For demodulation reference signal (DM-RS) transmission mode, the near-user can estimate the far-user's channel by means of separate DM-RS symbols. For common reference signal (CRS) transmission mode, the near-user can blindly detect far-user's precoder that is not signaled to the near-user. As a result, even the downlink control information (DCI) format is designed for the situation using the same precoder for superposed signals, the MUST scheme works and the near-user receiver can separate the superposed signal for the far-user.

In one embodiment, a UE receives configuration information from a serving base station for downlink multi-user superposition transmission (MUST) in a wireless communication network. The UE measures reference signals from the base station. The UE receives a first signal schedule to the first UE and a second superposed signal schedule to a second UE over an allocated time-frequency radio resource for MUST. The first signal is applied with a first precoder and the second signal is applied with a second precoder. The UE performs interference cancellation on the second superposed signal using the reference signals and thereby decoding the first signal. In one example, the reference signals comprise a first demodulation reference signal (DM-RS) configured to the first UE and a second DM-RS configured to the second UE. In another example, the reference signals comprise a common reference signal (CRS) configured to the first UE and the second UE.

Other embodiments and advantages are described in the detailed description below. This summary does not purport to define the invention. The invention is defined by the claims.

### BRIEF DESCRIPTION OF THE DRAWINGS

FIG. 1 illustrates a mobile communication network with different precoders applied for a downlink multiuser superposition transmission (MUST) scheme in accordance with one novel aspect.

FIG. 2 is a simplified block diagram of a base station and a user equipment that carry out certain embodiments of the present invention.

FIG. 3 illustrates a downlink MUST procedure with different precoders using DM-RS transmission mode in accordance with one novel aspect.

FIG. 4 illustrates a downlink MUST procedure with different precoders using CRS transmission mode in accordance with one novel aspect.

FIG. 5 illustrates a first embodiment for MUST scheme with different precoders in accordance with one novel aspect.

FIG. 6 illustrates a second embodiment for MUST scheme with different precoders in accordance with one novel aspect.

FIG. 7 illustrates a third embodiment for MUST scheme with different precoders in accordance with one novel aspect.

FIG. 8 is a flow chart of a method of performing MUST with different precoders from UE perspective in accordance with one novel aspect.

### DETAILED DESCRIPTION

Reference will now be made in detail to some embodiments of the invention, examples of which are illustrated in the accompanying drawings.

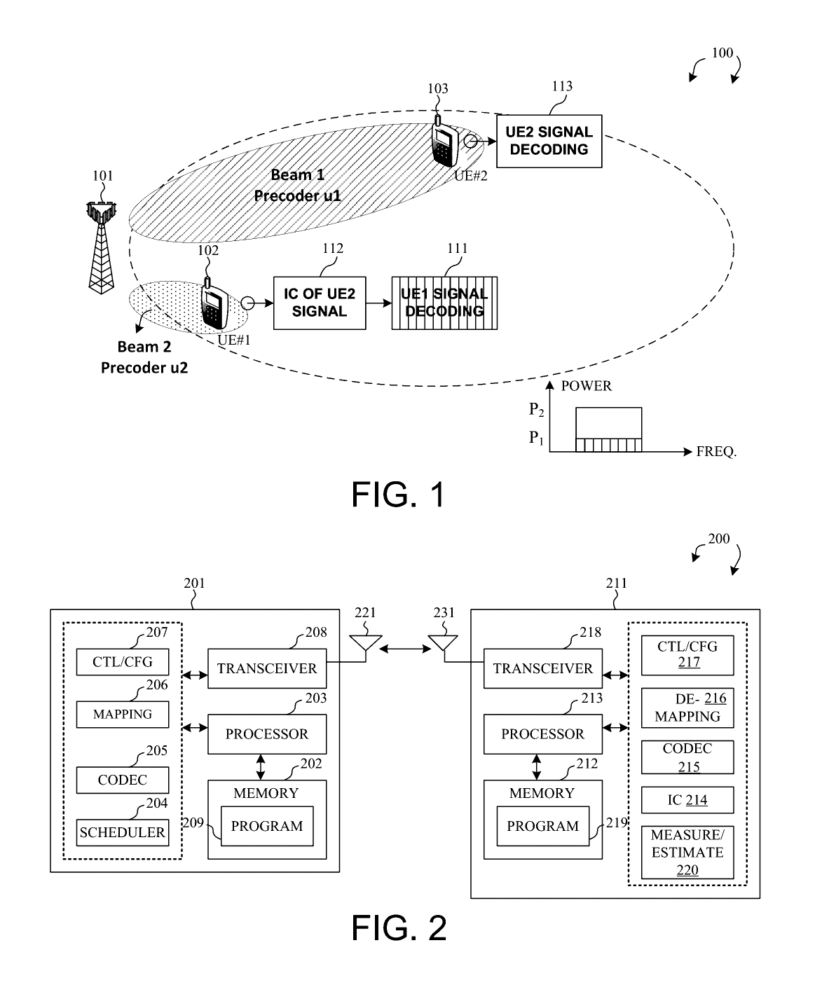

FIG. 1 illustrates a mobile communication network 100 with different precoders applied for a downlink multiuser superposition transmission (MUST) scheme in accordance with one novel aspect. Mobile communication network 100 is an OFDM network comprising a serving base station eNB 101, a first user equipment 102 (UE#1), and a second user equipment 103 (UE#2). In 3GPP LTE system based on OFDMA downlink, the radio resource is partitioned into subframes in time domain, each subframe is comprised of two slots. Each OFDMA symbol further consists of a number of OFDMA subcarriers in frequency domain depending on the system bandwidth. The basic unit of the resource grid is called Resource Element (RE), which spans an OFDMA subcarrier over one OFDMA symbol. REs are grouped into resource blocks (RBs), where each RB consists of 12 consecutive subcarriers in one slot.

Several physical downlink channels and reference signals are defined to use a set of resource elements carrying information originating from higher layers. For downlink channels, the Physical Downlink Shared Channel (PDSCH) is the main data-bearing downlink channel in LTE, while the Physical Downlink Control Channel (PDCCH) is used to carry downlink control information (DCI) in LTE. The control information may include scheduling decision, information related to reference signal information, rules forming the corresponding transport block (TB) to be carried by PDSCH, and power control command. For reference signals, Cell-specific reference signals (CRS) are utilized by UEs for the demodulation of control/data channels in non-precoded or codebook-based precoded transmission modes, radio link monitoring and measurements of channel state information (CSI) feedback. UE-specific reference signals (DM-RS) are utilized by UEs for the demodulation of control/data channels in non-codebook-based precoded transmission modes.

In the example of FIG. 1, downlink multiuser superposition transmission (MUST) scheme is used. In MUST, the signals intended for two users are superposed and occupy the same time-frequency radio resource. To benefit from MUST, the two co-scheduled users generally need to have a large difference in the received signal quality, e.g., in terms of the received signal-to-interference-plus-noise ratio (SINR). In a typical scenario, one of the users (e.g., UE#1) is geometrically close to the base station, and the other user (e.g., UE#2) is geometrically far away from the base station. The former user and the latter user are also referred to as the near-user and far-user respectively.

Consider a multiple-input multiple-output (MIMO) broadcast channel which models the downlink of a cellular communication system. The BS is equipped with Nₜ transmit antennas, and K UEs have Nr receive antennas each. At a time-frequency resource element, the BS performs MIMO transmission over B spatial beams (B<=Nₜ) to L (L<=K) UEs by linear precoding. It is assumed the MUST scheme is applied at the first spatial beam which transmits signals to two UEs. Based on the above description, the transmitted signal x can be expressed as:

$$x = {u}_{1} ( \sqrt{{α}_{N} {P}_{1}} {s}_{N} + \sqrt{{α}_{F} {P}_{1}} {s}_{F} ) + {\sum }_{i = 2}^{B} {u}_{i} {\sum }_{j} \sqrt{{α}_{i , j} {P}_{i}} {s}_{i , j} \qquad ( 1 )$$

### Where

Uᵢ is the unit-norm precoder applied at beam i
Pᵢ is the transmitted power allocated at beam i
0<α_{N}<1 is the power splitting factor for the near-user
α_{F}=1−α_{N} is the power splitting factor for the far-user
s_{N} and s_{F} are the modulated symbols of the near-user and the far-user, respectively
\sqrt{α_{i,j}Pᵢ}s_{i,j} is the j-th power-scaled modulated symbol carried at beam i

As shown in FIG. 1, UE#1 receives intra-cell interfering radio signal 112 transmitted from the same serving eNB 101 due to non-orthogonal multiple access (NOMA) operation intended for multiple UEs (e.g., UE#2) in the same serving cell. UE#1 may be equipped with an interference cancellation (IC) receiver that is capable of cancelling the contribution of the interfering signal 112 from the desired signal 111. For NOMA operation, the signals to the two UEs are superposed and precoded and transmitted. The received signal y_{N} at near-user is obtained after intercell-interference-plus-noise whitening and is given as the following equation:

$$\begin{matrix}{y}_{N} = {H}_{N} x + w \\ = {h}_{N , 1} ( \sqrt{{α}_{N} {P}_{1}} {s}_{N} + \sqrt{{α}_{F} {P}_{1}} {s}_{F} ) + {\sum }_{i = 2}^{B} {h}_{N , i} {\sum }_{j} \sqrt{{α}_{i , j} {P}_{i}} {s}_{i , j} + w\end{matrix} \qquad ( 2 )$$

### Where

H_{N} is the effective channel matrix of the near-user after whitening, h_{N,i}=H_{N}uᵢ for 1<=i<=B
uᵢ is the unit-norm precoder applied at beam i
Pᵢ is the transmitted power allocated at beam i
0<α_{N}<1 is the power splitting factor for the near-user
α_{F}=1−α_{N} is the power splitting factor for the far-user
s_{N} and s_{F} are the modulated symbols of the near-user and the far-user, respectively
\sqrt{α_{i,j}Pᵢ}s_{i,j} is the j-th power-scaled modulated symbol carried at beam i
w denotes the whitened contribution of the interfering signal plus the thermal noise. The entries of w are zero-mean independent and identically distributed (i.i.d) complex Gaussian random variables with variance N₀.

Due to the complexity of the scheduling algorithm and the overhead of the channel state information (CSI) feedback, it is generally assumed that the same precoder is applied to superpose signals in the downlink MUST scheme. More specifically, the design of the downlink control information (DCI) and CSI feedback for the MUST transmission mode is concentrated and optimized for the case that the same precoder is applied to the superposed signals. However, confining the precoder selection may degrade the performance gain of MUST due to the limited user pairing opportunities.

In accordance with one novel aspect, when different precoders are applied to superposed signals, the MUST scheme still works based on the DCI format designed for the situation of using the same precoder for superposed signals. As illustrated in FIG. 1, distinct precoders u₁ and u₂ are applied to the symbols s_{F} and s_{N}, respectively. For demodulation reference signal (DM-RS) transmission mode, the near-user UE#1 can estimate the far-user UE#2 's channel by means of separate DM-RS symbols. For common reference signal (CRS) transmission mode, the near-user UE#1 can blindly detect far-user UE#2 's precoder that is not signaled to UE#1. As a result, even the DCI format is designed for the situation using the same precoder for superposed signals, the MUST scheme still works and the near-user receiver can still separate the superposed signal for the far-user.

FIG. 2 is a simplified block diagram of a base station 201 and a user equipment 211 that carry out certain embodiments of the present invention in a mobile communication network 200. For base station 201, antenna 221 transmits and receives radio signals. RF transceiver module 208, coupled with the antenna, receives RF signals from the antenna, converts them to baseband signals and sends them to processor 203. RF transceiver 208 also converts received baseband signals from the processor, converts them to RF signals, and sends out to antenna 221. Processor 203 processes the received baseband signals and invokes different functional modules to perform features in base station 201. Memory 202 stores program instructions and data 209 to control the operations of the base station. Similar configuration exists in UE 211 where antenna 231 transmits and receives RF signals. RF transceiver module 218, coupled with the antenna, receives RF signals from the antenna, converts them to baseband signals and sends them to processor 213. The RF transceiver 218 also converts received baseband signals from the processor, converts them to RF signals, and sends out to antenna 231. Processor 213 processes the received baseband signals and invokes different functional modules to perform features in UE 211. Memory 212 stores program instructions and data 219 to control the operations of the UE.

Base station 201 and UE 211 also include several functional modules and circuits to carry out some embodiments of the present invention. The different functional modules are circuits that can be configured and implemented by software, firmware, hardware, or any combination thereof. The function modules, when executed by the processors 203 and 213 (e.g., via executing program codes 209 and 219), for example, allow base station 201 to schedule (via scheduler 204), encode (via codec 205), mapping (via mapping circuit 206), and transmit control/config information and data (via control/config circuit 207) to UE 211, and allow UE 211 to receive, de-mapping (via de-mapper 216), and decode (via codec 215) the control/config information and data (via control/config circuit 217) accordingly with interference cancellation capability. In one example, base station 201 provides assistant information that include parameters related to interfering signals to UE 211. Upon receiving the related parameters, UE 211 is then able to perform interference cancellation via interference canceller 214 to cancel the contribution of the interfering signals accordingly. In another example, UE 211 performs reference signal detection and performs measurements and channel estimation via a measurement/estimation module 220. UE 211 (e.g., the near-user) is able to estimate a far-user channel by means of separate DM-RS symbols or by blind decoding of the far-user precoder for superposed signal using CRS under a MUST scheme when different precoders are applied to the near-user and far-user.

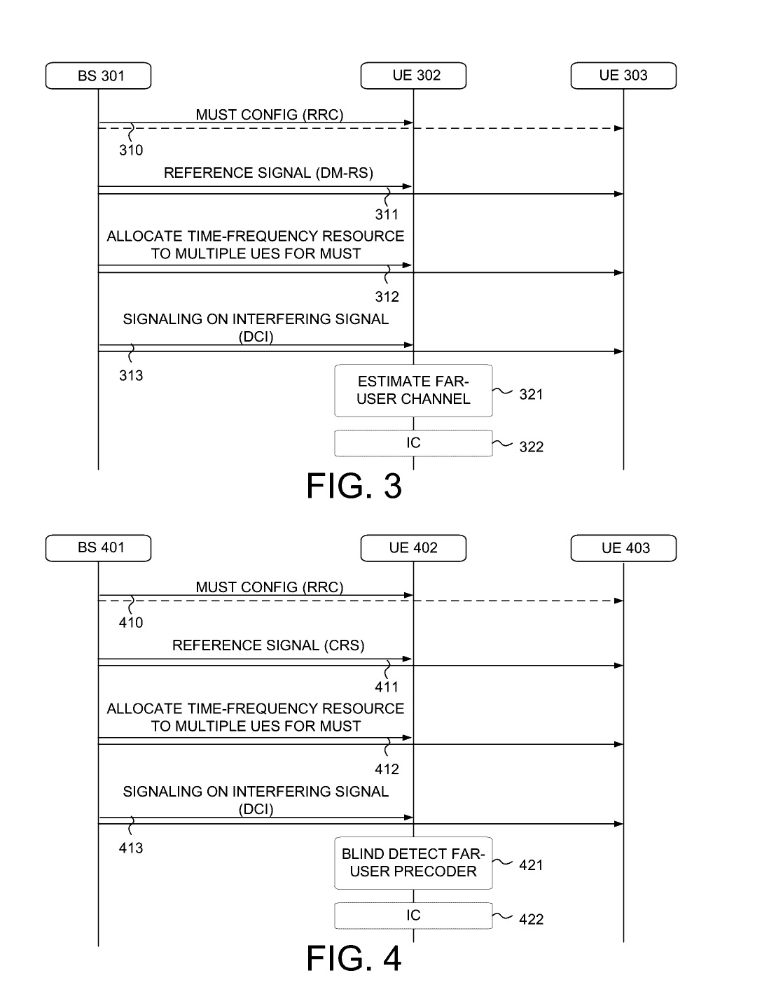

FIG. 3 illustrates a downlink MUST procedure with different precoders using DM-RS transmission mode in accordance with one novel aspect. In a DM-RS based transmission mode of an LTE system, the channel estimation for data detection is performed on the DM-RS. A DM-RS pilot symbol s_{DM-RS} carried on the DM-RS resource element is precoded by the precoder uᵢ applied at the spatial beam i. That is the signal transmitted to the air interface over the transmit antennas and received by the receive antennas are HUᵢs_{DM-RS}for the channel H. Using the known pilot symbol s_{DM-RS}, the receiver can estimate the effective channel matrix Huᵢ.

In the example of FIG. 3, BS 301 performs MIMO transmission to UE 302 (near-user) and UE 303 (far-user). It is assumed that the MUST scheme is applied at the first spatial beam which transmits signals to the two UEs. In step 310, BS 301 sends MUST configuration information to near UE 302 via high layer signaling (e.g., via RRC). The MUST configuration information tells UE 302 that it is configured with MUST and informs the corresponding transmission mode. Alternatively, BS 301 optionally also sends the MUST configuration to far UE 303 as depicted by the dashed line. In step 311, BS 301 transmits DM-RS reference signals to UE 302 and UE 303. In step 312, BS 301 allocates time-frequency radio resource to UE 302 and UE 303 for MUST. In step 313, BS 301 signals information of the superposed interfering signals to the UEs (e.g., via PDCCH/DCI). In step 321, UE 302 performs channel estimation for the far-user's signal by using the DM-RS of the far-user. In step 322, UE 302 performs interference cancellation of the far-user's signal and thereby decoding its own signal.

In the above example, the received signal at the near-user UE 302 can be represented by equation (2). According to equation (2), at the near-user receiver, the symbols s_{N} and s_{F} intended for the near-user and far-user experience the same effective channel h_{N,1}. Therefore, it looks as if one common pilot symbol could be used for the estimation of h_{N,1}. However, since symbol detection requires the power information and \sqrt{α_{N}P₁} and \sqrt{α_{F}P₁} as well, it is proposed that two separate pilot symbols carried in the DM-RS RE are configured for the estimate of channel vectors h_{N,1}\sqrt{α_{N}P₁} and h_{N,1}\sqrt{α_{F}P₁} of the near-user and the far-user. With separate DM-RS pilot symbols, power split factor is blindly estimated, not needed to be signaled via DCI. The near-user can do channel estimation for far-user's signal in case of different precoders. There is no need to detect the far-user's precoder.

Based on such design, consider the situation that distinct precoders u₁ and u₂ are applied to the symbols s_{F} and s_{N}, respectively, as shown in FIG. 1. The received signal at the near-user is given as:

y_{N}=H_{N}(u₁\sqrt{α_{F}P}s_{F}+u₂\sqrt{α_{N}P}s_{N})+w=h_{N,1}\sqrt{α_{F}P}s_{F}+h_{N,2}\sqrt{α_{N}P}s_{N}+w (3)

### Where

h_{N,i}=H_{N}uᵢ for i=1, 2. The channel vectors h_{N,1}\sqrt{α_{N}P₁} and h_{N,1}\sqrt{α_{F}P₁} can be estimated by means of separate pilot symbols carried in DM-RS.

When UE 302 performs channel estimation h_{N,1}\sqrt{α_{N}P₁} by pilot symbol carried in DM-RS, the quality of channel estimation may not be good when the power splitting factor α_{N} is small. The eNB may multiply a power boosting factor γ>1 known to UE 302 on the pilot symbol so that the channel estimation quality can be improved.

FIG. 4 illustrates a downlink MUST procedure with different precoders using CRS transmission mode in accordance with one novel aspect. In an LTE CRS based transmission mode, the channel estimation for data detection is performed on the CRS. A CRS pilot symbol s_{CRS} carried on the CRS resource element is not precoded by the precoder. Therefore, a user estimates the channel matrix H via CRS pilot symbols, and the information of the precoder applied to data needs to be additionally signaled to the user for data detection.

Consider the scenario shown FIG. 1. Since the signaling design of MUST assumes the same precoder is used for superposed signals, only the information of one precoder (e.g., u₂, since it is the precoder for s_{N}) is signaled to the near-user. However, without the knowledge of u₁, the near-user cannot detect the interfering symbol s_{F}. It is proposed that, when configured with a CRS based MUST transmission mode, the near-user performs blind detection in the received signal for other precoders that are not contained in the signaling information, e.g., the DCI in the physical downlink control channel (PDCCH) in LTE.

In the example of FIG. 4, BS 401 performs MIMO transmission to UE 402 (near-user) and UE 403 (far-user). It is assumed that the MUST scheme is applied at the first spatial beam which transmits signals to the two UEs. In step 410, BS 401 sends MUST configuration information to near UE 402 via high layer signaling (e.g., via RRC). The MUST configuration information tells UE 402 that it is configured with MUST and informs the corresponding transmission mode. Alternatively, BS 401 optionally also sends the MUST configuration to far UE 403 as depicted by the dashed line. In step 411, BS 401 transmits CRS reference signals to UE 402 and UE 403. In step 412, BS 401 allocates time-frequency radio resource to UE 402 and UE 403 for MUST. In step 413, BS 401 signals information of the superposed interfering signals to the UEs (e.g. via PDCCH/DCI). Since it is assumed that the same precoder is used for superposed signals, such signaling information does not include other UE's precoder. In step 421, UE 402 blindly detect UE 403′s precoder. In step 422, UE 402 performs interference cancellation of the far-user's signal and decodes its own signal.

The blind detection of other UE's precoder is feasible when the number of transmit antennas Nₜ is not large. Take an LTE system as an example. The precoder selection in a CRS based transmission mode is codebook based. When Nₜ=2, the number of precoders is no more than four, and the complexity and performance of precoder blind detection should not be a problem. The near-user can decide whether to believe different precoders are applied to superposed signals based on some additional information, for example, the ratio between the received powers on the signaled precoder and on the detected precoder; the confidence of signal detection on the detected precoder; and the reliability of signal detection on the detected precoder.

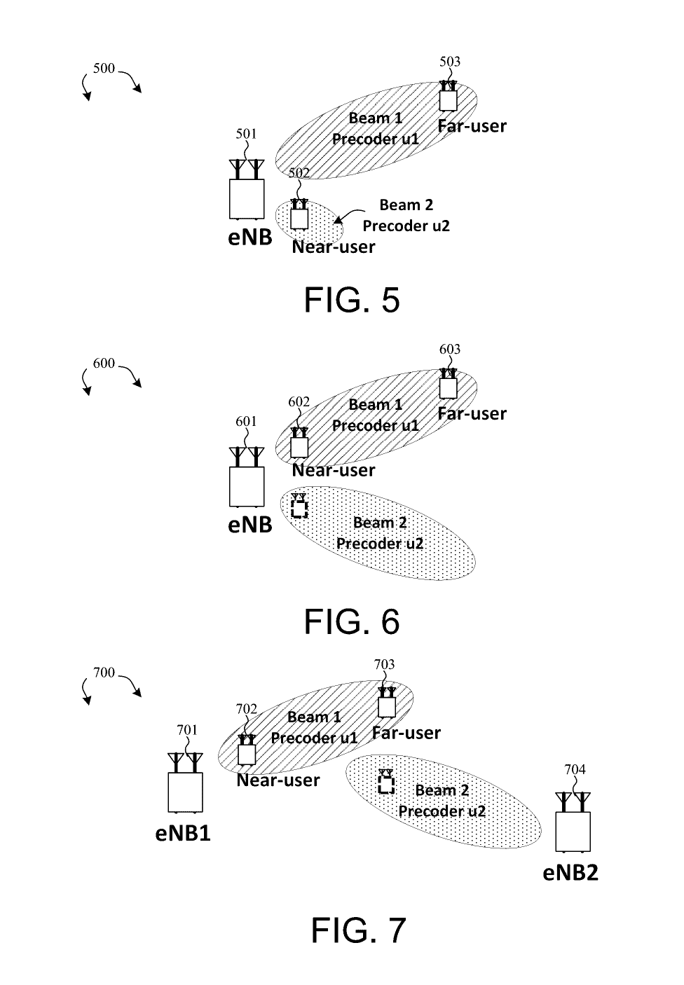

FIG. 5 illustrates a first embodiment for MUST scheme with different precoders in accordance with one novel aspect. In the embodiment of FIG. 5, BS 501 applies a MUST scheduling scheme to near-user UE 502 and far-user UE 503. Two distinct precoders u₁ and u₂ are applied to the symbols s_{F} and s_{N} to the far-user and the near-user respectively. In most cases, the near-user can detect the precoder u₁, which has a much higher power than the signaled precoder u₂. Note that, in this scenario, the directions of precoder u₁ and u₂ are generally quite aligned so that the near-user can receive a strong power from beam 1 of u₁. Therefore, in general, the reliability of signal detection at u₁ is high.

FIG. 6 illustrates a second embodiment for MUST scheme with different precoders in accordance with one novel aspect. In the embodiment of FIG. 6, BS 601 applies a MUST scheduling scheme to near-user UE 602 and far-user UE 603. The same precoder u₁ is applied to the near-user and the far-user at beam 1. However, BS 601 also applies precoder u₂ to another user at beam 2 under MU-MIMO. At the near-user receiver, the power from the beam 2 of u₂ is generally weaker than the power of the signaled precoder u₁. The action of cancelling the signal carried at the precoder u₂ is equivalent to inter-beam interference cancellation in MU-MIMO.

FIG. 7 illustrates a third embodiment for MUST scheme with different precoders in accordance with one novel aspect. In the embodiment of FIG. 7, BS 701 applies a MUST scheduling scheme to near-user UE 702 and far-user UE 703. The same precoder u₁ is applied to the near-user and the far-user at beam 1. However, another BS 704 applies precoder u₂ to another user at beam 2. This is the scenario that is of interest in the study of Network Assisted Interference Cancellation and Suppression (NAICS). The near-user can try to cancel the interference signal under network assistance.

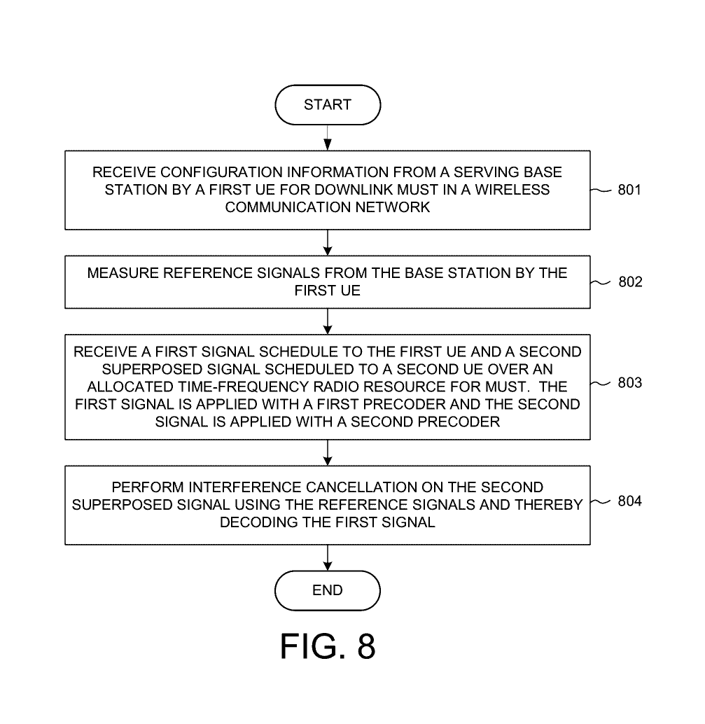

FIG. 8 is a flow chart of a method of performing MUST with different precoders from UE perspective in accordance with one novel aspect. In step 801, a UE receives configuration information from a serving base station for downlink multi-user superposition transmission (MUST) in a wireless communication network. In step 802, the UE measures reference signals from the base station. In step 803, the UE receives a first signal schedule to the first UE and a second superposed signal schedule to a second UE over an allocated time-frequency radio resource for MUST. The first signal is applied with a first precoder and the second signal is applied with a second precoder. In step 804, the UE performs interference cancellation on the second superposed signal using the reference signals and thereby decoding the first signal. In one example, the reference signals comprise a first demodulation reference signal (DM-RS) configured to the first UE and a second DM-RS configured to the second UE. In another example, the reference signals comprise a common reference signal (CRS) configured to the first UE and the second UE.

Although the present invention has been described in connection with certain specific embodiments for instructional purposes, the present invention is not limited thereto. Accordingly, various modifications, adaptations, and combinations of various features of the described embodiments can be practiced without departing from the scope of the invention as set forth in the claims.

What is claimed is:

1. A method comprising:
receiving configuration information from a serving base station by a first user equipment (UE) for downlink multiuser superposition transmission (MUST) in a wireless communication network;
measuring reference signals from the base station by the first UE;
receiving a first signal scheduled to the first UE and a second superposed signal scheduled to a second UE over an allocated time-frequency radio resource for MUST, wherein the first signal is applied with a first precoder and the second signal is applied with a second precoder; and
performing interference cancellation on the second superposed signal using the reference signals and thereby decoding the first signal.

2. The method of claim 1, wherein the reference signals comprise a first demodulation reference signal (DM-RS) configured to the first UE and a second DM-RS configured to the second UE.

3. The method of claim 2, wherein the first and second DM-RS are applied with the first and the second precoders, respectively.

4. The method of claim 2, wherein the first and the second DM-RS are applied with power splitting factors between the first UE and the second UE for MUST.

5. The method of claim 2, wherein the first DM-RS is applied with a power boosting factor to enhance a channel estimation for the first UE.

6. The method of claim 2, wherein the first UE estimates an effective channel response matrix of the second UE based on the second DM-RS without detecting the second precoder.

7. The method of claim 1, wherein the reference signals comprise a common reference signal (CRS) configured to the first UE and the second UE.

8. The method of claim 7, wherein the configuration information includes the first precoder but does not include the second precoder.

9. The method of claim 7, wherein the first UE estimates a channel response matrix of the second UE based on the CRS, and wherein the first UE blindly detects the second precoder.

10. The method of claim 9, wherein the first UE determines whether a blindly detected precoder is accurate based on addition information including a received power ratio between the first signal and the second signal.

11. A User Equipment (UE) comprising:
a controller that handles configuration information from a serving base station for downlink multiuser superposition transmission (MUST) in a wireless communication network;
a measurement circuit that measures reference signals from the base station by the UE;
a receiver that receives a first signal scheduled to the UE and a second superposed signal scheduled to a second UE over an allocated time-frequency radio resource for MUST, wherein the first signal is applied with a first precoder and the second signal is applied with a second precoder; and
an interference canceller (IC) that performs interference cancellation on the second superposed signal using the reference signals and thereby decoding the first signal.

12. The UE of claim 11, wherein the reference signals comprise a first demodulation reference signal (DM-RS) configured to the UE and a second DM-RS configured to the second UE.

13. The UE of claim 12, wherein the first and second DM-RS are applied with the first and the second precoders, respectively.

14. The UE of claim 12, wherein the first and the second DM-RS are applied with power splitting factors between the UE and the second UE for MUST.

15. The UE of claim 12, wherein the first DM-RS is applied with a power boosting factor to enhance a channel estimation for the UE.

16. The UE of claim 12, wherein the UE estimates an effective channel response matrix of the second UE based on the second DM-RS without detecting the second precoder.

17. The UE of claim 11, wherein the reference signals comprise a common reference signal (CRS) configured to the first UE and the second UE.

18. The UE of claim 17, wherein the configuration information includes the first precoder but does not include the second precoder.

19. The UE of claim 17, wherein the UE estimates a channel response matrix of the second UE based on the CRS, and wherein the UE blindly detects the second precoder.

20. The UE of claim 19, wherein the UE determines whether a blindly detected precoder is accurate based on addition information including a received power ratio between the first signal and the second signal.
